(19) United States
(12) Patent Application Publication
(10) Pub. No.: US 2023/0148606 A1
(43) Pub. Date: May 18, 2023

(54) IMPROVED TUNGSTEN-CONTAINING ANTI-MICROBIAL COMPOSITE MATERIALS

(71) Applicant: Frida Group APS, Dragor (DK)

(72) Inventor: Josef Peter GUGGENBICHLER, Kössen in Tirol (AT)

(73) Assignee: Frida Group APS, Dragor (DK)

(21) Appl. No.: 17/906,537

(22) PCT Filed: Mar. 17, 2021
(86) PCT No.: PCT/EP2021/056800

§ 371 Date: Sep. 16, 2022

(30) Foreign Application Priority Data
Mar. 17, 2020 (WO) 20163516.6

(51) Int. Cl. A01N 59/16; A01N 25/26; A01P 1/00

(52) U.S. Cl. CPC A01N 59/16; A01N 25/26; A01P 1/00

(57) ABSTRACT

The invention relates to the use of tungsten blue as an antimicrobial agent, composite materials comprising tungsten blue, and methods for the preparation thereof.

The invention relates to the use of tungsten blue as an antimicrobial agent, composite materials comprising tungsten blue, and methods for the preparation thereof.

In order to prevent the accumulation of microorganisms, surfaces of articles are treated with antimicrobial agents or are equipped with antimicrobial properties. Among others, disinfectants and biocides, respectively, are used to fight microorganisms. However, a major disadvantage of the use of organic biocides is development of resistance and cross-resistance among microorganisms. Therefore, alternatives are increasingly being sought to effectively fight microorganisms and prevent the population of surfaces with microorganisms. One possibility is the use of metals and metal compounds. Due to their good antimicrobial effect, in particular silver and copper are frequently used. In a first variant, the elemental metal is provided in a form with the largest possible surface area in order to achieve a high level of activity. In particular, nanoparticles, foamed metal, or nanoparticles fixed on a carrier are to be considered in this regard. A second variant provides for the provision of soluble metal salts, which are, for example, incorporated in zeolites or directly in a composite material. A disadvantage, however, is that the mentioned noble metals or noble metal ions, respectively, are comparatively expensive and further are almost completely inactivated by sulfur-containing compounds or high electrolyte concentrations.

Recently, the use of compounds containing molybdenum and tungsten, in particular molybdates and molybdenum oxides as well as tungstates and tungsten oxides, as antimicrobial agents has also been discussed. These compounds are comparatively inexpensive and are also non-toxic, as they are virtually insoluble in water. Tungsten(VI) oxide (WP₃) is a crystal powder that has an intensely yellow color at room temperature, and is orange when heated. The crystal lattice of rhombic WO₃ consists of WO₆ octahedra that are connected by common corners in the three spatial directions. Tungsten trioxide is completely insoluble in water and acids, but can react with water to form tungstic acid. The biocidal effect of tungsten trioxide is based on the associated decrease of the pH value in the surrounding medium. However, the antimicrobial efficacy of WO₃ and other molybdenum and tungsten compounds, which have been examined so far, is often insufficient.

WO 2015/091993 describes methods for the preparation of an antimicrobially active composite and a corresponding antimicrobially active material. The printed document does not disclose the use of tungsten blue as an antimicrobial composite active material, wherein tungsten blue is oxygen-deficient WO₃ minus 1-10 mole % oxygen or WO₃ minus 5 mole % oxygen. Furthermore, no highly effective preparations of oxygen-deficient WO₃ with particles of a preferred particle size are described. No reference to the oxygen content of WO₃ is given in the printed document WO 2015/091993. Mixtures of oxygen-saturated tungsten yellow and oxygen-deficient tungsten blue appear blue and, as a rule, are therefore often erroneously referred to overall as tungsten blue.

Therefore, the object of the present invention is to provide an antimicrobial agent having improved activity as well as to provide a cost-effective possibility of effectively protecting materials and surfaces against the population of microorganisms.

In addition to tungsten trioxide, other oxides of tungsten are also known. Yellow tungsten(VI) oxide eventually changes to brown tungsten(IV) oxide when exposed to reducing agents. By reduction of freshly precipitated tungsten(VI) oxide hydrate, according to

WO₃+xH→WO₃₋ₓ(OH)ₓ

deep blue solutions of hydrated mixed oxides of hexavalent to pentavalent tungsten are obtained. These blue tungsten(VI)-tungsten(V) mixed oxides are collectively referred to as “tungsten blue”.

In the present invention, it was surprisingly found that tungsten blue shows significantly higher antimicrobial activity than tungsten trioxide. At the same particle size, the efficacy of tungsten blue is significantly better than that of tungsten trioxide.

Thus, a first aspect of the present invention relates to the use of tungsten blue as an antimicrobial agent.

According to the invention, “tungsten blue” refers to an oxygen-deficient tungsten trioxide, wherein tungsten is present in oxidation states between VI and V. In contrast, “tungsten yellow” is oxygen-saturated tungsten trioxide. In particular, tungsten blue can be described as WO₃ minus about 1 to 10 mole % oxygen, more preferably WO₃ minus about 4-6 mole % oxygen, preferably WO₃ minus about 5 mole % oxygen, most preferably minus 5 mole % oxygen. Accordingly, “oxygen-deficient WP₃” according to the present invention preferably describes WO₃ minus about 5 mole % oxygen. It was found that in particular tungsten blue according to the present invention, i. e. tungsten blue which is preferably 5% oxygen-deficient, has an excellent antimicrobial activity and is active against a wide variety of germs. In this context, it should be noted that tungsten oxides, which contain small amounts of tungsten blue, already have a bluish color. Mixtures of tungsten yellow with tungsten blue appear blue and are therefore often (incorrectly) referred to as tungsten blue overall. Preferably, no tungsten yellow or oxygen-saturated WO₃ is present in the corresponding tungsten blue preparation. However, for the purposes according to the present invention, tungsten blue is in fact understood to mean only oxygen-deficient WP₃, in particular WO₃ minus about 5 mole % oxygen. Preferably, oxygen-saturated WO₃ (tungsten yellow) is not present.

In accordance with the present invention, preferably tungsten blue preparations are used which are substantially free or free of oxygen-saturated WO₃ (tungsten yellow), respectively. Preferably, antimicrobial composites according to the present invention accordingly do not have an oxygen-saturated WO₃ (tungsten yellow) content. Since oxygen-saturated WO₃ is not antimicrobially active, the proportion of tungsten contained in the composite material can be kept lower without loss of antimicrobial activity by completely dispensing with oxygen-saturated WP₃.

Tungsten blue is non-toxic to human beings and animals and thus exhibits excellent biocompatibility. It can be produced comparatively inexpensively and shows strong antimicrobial activity even in small amounts.

Tungsten blue has a high antimicrobial activity against a wide range of microorganisms, including fungi and viruses, as well as Gram-positive and Gram-negative microorganisms regardless of their antibiotic resistance. Examples of microorganisms against which tungsten blue is effective according to the present invention include, but are not limited to, Lactobacillus acidophilus, Pseudomonas, e. g., P. aeruginosa, Salmonella, e.g., S. aureus, E. coli, Candida Spp, C. albicans, C. glabrata and C. tropicalis, legionella, listerias; viruses, e.g. influenza, Ebstein-Barr viruses, rotaviruses and noroviruses; as well as Aspergillus niger, fumigatus and flavus. The antimicrobial activity is significantly increased at the same grain size compared to tungsten(VI) oxide (yellow).

In a particularly preferred embodiment, oxygen-deficient tungsten blue according to the present invention is used as an antimicrobial agent against S. aureus, E. coli and/or P. aerug.

According to the present invention, particularly good antimicrobial efficacy was found for tungsten blue in the form of particles having an average particle size between 0.1 μm and 0.9 μm. Preferably, the mean particle size of tungsten blue is in the range of 0.2 to 0.7 μm, further preferably 0.25 to 0.5 μm. Particles that are smaller than 0.1 μm and in particular nanoparticles are not provided according to the present invention. It has been found that excellent antimicrobial efficacy is achieved with tungsten blue at a particle size in the above-mentioned range, so that the risks associated with nanoparticles can be avoided. A particularly preferred embodiment relates to the use of oxygen-deficient WP₃, i. e., WO₃ minus about 5 mole % oxygen (tungsten blue) as an antimicrobial agent, wherein said tungsten blue is in the form of particles having an average grain size between 0.20 to 0.5 μm and more preferably 0.25 to 0.5 μm, and the tungsten blue preparation preferably has no particles with a grain size of less than 0.1 μm. The prior art does not provide any hint to the person skilled in the art as to the corresponding superior combination of features. This in particular applies to “tungsten blue compositions” as cited in the prior art.

Advantageously, according to the present invention, tungsten blue is used which essentially does not have particles having a grain size that is smaller than 0.1 μm. It is further preferred that substantially no particles having a grain size greater than 0.9 μm are contained. A narrow particle size distribution ensures particularly high antimicrobial efficacy while avoiding the risks that are associated with nanoparticles.

Tungsten blue itself is insoluble in water. Upon contact with water, or atmospheric moisture, tungsten blue causes a lowering of the pH value. Tungsten blue itself does not dissolve and is not degraded or washed out of a material.

For antimicrobial use, tungsten blue can be used alone or in combination with other active ingredients and/or excipients. Preferably, WO₃ is not present.

Further advantages result when tungsten blue is used in combination with at least one hydrophilizing or hygroscopic agent. Particularly preferred hydrophilizing and hygroscopizing agents are described in the following.

According to the present invention, tungsten blue can be incorporated into or at least deposited on the surface of a material that is to be equipped with antimicrobial properties. In this way, an antimicrobially active composite material results.

Accordingly, a further object of the present invention is an antimicrobially active composite material comprising tungsten blue and at least one further material. Thereby, the average grain size of tungsten blue is preferably between 0.1 μm and 0.9 μm as indicated above, further preferably 0.2 to 0.7 μm and particularly preferably in the range of 0.25 μm to 0.5 μm. Particles that are smaller than 0.1 μm and in particular nanoparticles are not provided according to the present invention. The composite material according to the present invention is preferably free of oxygen-saturated WO₃ (tungsten yellow).

For the purposes of the present invention, a composite material is understood to be a material consisting of two or more materials bonded together, wherein at least one of the materials is the tungsten blue as defined above. The further material can in principle be formed from any material and can, for example, also itself constitute a composite material.

The presence of tungsten blue imparts an antimicrobial effect to a composite material according to the present invention. The adhesiveness of pathogenic germs is reduced to a great extent. The proliferation of microorganisms as well as the formation of biofilms are inhibited. For example, this is of particular importance in hospitals, nursing homes, etc., since microorganisms in biofilms cannot be removed, or at least not permanently removed, by antibiotics, organic biocides, disinfectants and the like. Since a lowering of the pH is only required in the region of the surface boundary layer of the composite, or of a component or product made from it, correspondingly small amounts of tungsten blue in the region of the surface are sufficient to achieve the desired antimicrobial efficacy.

Tungsten blue is essentially not water soluble, so it is not washed out of the composite but remains there and maintains its antimicrobial efficacy throughout the lifetime of the composite material.

The at least one further material of the composite material can in principle be selected from any class of materials. For example, it may be an inorganic, metallic, ceramic or organic material or any combination thereof. In principle, further materials may be, for example, plastics, paints, lacquers, silicones, rubber, rubber, melamine, acrylates, methyl acrylates, waxes, epoxy resins, glass, metal, ceramics and others. In a preferred embodiment, the composite material according to the present invention comprises as a further material at least one organic polymer, or a compound and/or a silicone. Examples of organic polymers include polyethylene (PE) and polypropylene (PP).

The material into or onto which the tungsten blue is introduced for the purpose of antimicrobial equipment may form a solid and/or liquid matrix. It may be provided that tungsten blue is added such that it constitutes between 0.1% and 10% (percent by weight or volume) of the total weight or total volume. Preferably, the amount of tungsten blue is 1-3% by weight.

In principle, the composite material can be formed as a layered composite, fiber composite, particle composite or interpenetration composite.

In principle, the composite material according to the present invention can be present in solid or liquid form at standard conditions. For example, the composite material can be in the form of a solution, suspension and/or dispersion, for example as a lacquer or liquid coating agent, respectively.

Tungsten blue may be disposed on the surface of the composite material and/or distributed in the composite material. Preferably, according to the present invention, tungsten blue is arranged at least in the region of the surface of the composite material, since here an antimicrobial effect is desired. For example, tungsten blue can be applied to a substrate or carrier material as a layer or component of a layer. In this case, the substrate or carrier material is subject to virtually no structural or material restrictions. In principle, only one or more areas of the surface or the entire surface of the composite material can be antimicrobially equipped by tungsten blue. Alternatively or additionally, tungsten blue can also be arranged within the composite material or can be distributed within the composite material, respectively. This ensures that the antimicrobial effect is permanently maintained even in the event that the composite material wears on its surface.

Depending on the intended use, the composite material in the context of the present invention can basically be present as a semi-finished product, i.e., as a semi-finished material that obtains its final form of use only after further processing steps. Alternatively, the composite material may already be designed as a finished component which can be used for its desired intended purpose without further processing steps.

In a composite material according to the present invention, tungsten blue may be present alone or in combination with other active ingredients and/or adjuvants.

In a preferred embodiment, a composite material according to the present invention does not have any additional antimicrobially active compounds, such as silver or silver compounds, in particular nanosilver or soluble silver compounds such as silver nitrate or the like, in addition to tungsten blue.

Copper, organic biocides, zeolites and the like are also preferably not present in a composite material according to the present invention. In this way, an improved environmental compatibility and a considerable reduction in costs are achieved. Preferably, tungsten yellow is also not present.

The mass content of tungsten blue relative to the total mass of the composite is advantageously between 0.1 and 80% by weight, in particular between 1.0 and 30% by weight and preferably between 1.5 and 5.0% by weight. At this mass ratio, a particularly high antimicrobial efficacy is ensured with the lowest possible material input of tungsten blue.

In principle, any adjuvants which are common in the art can be considered as adjuvants in a composite material according to the present invention. It is understood that possible adjuvants may vary depending on the particular material of the composite material. Preferably, conventional dispersants, antistatic agents, wetting agents, emulsifiers, etc. are used.

The use of particles with the aforementioned average particle sizes offers the particular advantage that, on the one hand, a particularly high antimicrobial efficacy can be realized and, on the other hand, the composite material according to the present invention is free of nanoparticles.

Further advantages result when tungsten blue is used in combination with at least one hydrophilizing or hygroscopic agent, which is arranged at least in the region of the surface of the composite material. In this way, antimicrobial efficacy is substantially increased in particularly dry environments, i.e., for example, with very low humidity and correspondingly low amounts of available water, which are important for the formation of an acidic surface boundary layer. Examples of suitable hydrophilizing and/or hygroscopic agents include SiO₂, in particular in the form of silica gel or as fumed silica. These form a kind of moisture buffer and thus ensure a minimum moisture content in the product. It has also been found that the association of tungsten blue with SiO₂ causes tungsten blue to be retained particularly well in the composite material and washing out can be completely prevented. SiO₂ is preferably used with a particle size distribution in the range of between 0.25 μm and 25 μm average particle diameter.

Further examples of other hydrophilizing and/or hygroscopic agents that can be used according to the present invention are organic acids, such as abietic acid, arachidonic acid, arachidic acid, behenic acid, capric acid, caproic acid, cerotic acid, erucic acid, fusaric acid, fumaric acid, bile acids, icosenoic acid, isophthalic acid, lactonic acid, lauric acid, lignoceric acid, Linolenic acid, levopimaric acid, linoleic acid, margaric acid, melissic acid, montanic acid, myristic acid, neoabietic acid, nervonic acid, nonadecanoic acid, oleic acid, palmitic acid, palmitoleic acid, pelargonic acid (nonanoic acid), pimaric acid, palustric acid, palmitic acid, ricinoleic acid, stearic acid, sorbic acid, tannic acid, tridecanoic acid, undecanoic acid and vulpinic acid. Furthermore, malonic acid, maleic acid and maleic anhydride, lactic acid, acetic acid, citric acid, salicylic acid and ascorbic acid, as well as their salts, have proven advantageous. Acid anhydrides, ampholytic substances, buffer systems, polymer acids, ion exchange resins, as well as acid sulfonates and acid halides can also be used.

The mass content of hydrophilizing and/or hygroscopic agents relative to the total weight of the composite material is advantageously in the range of 0.1 and 15%. For example, the mass content may be 0.5%, 1%, 2%, 3%, 4%, 5%, 6%, 7%, 8%, 9%, 10%, 11%, 12%, 13% or 14%. Particularly advantageous is a mass content in the range of between 1 and 5%, preferably in the range of 2-4%. Furthermore, the mass content or mass ratio of the hydrophilizing and/or hygroscopic agent can be adjusted such that it corresponds to the selected mass content of tungsten blue.

In a particularly preferred embodiment, tungsten blue is at least partially coated and/or agglomerated with the hydrophilizing and/or hygroscopic agent, in particular SiO₂. This ensures in a simple manner a spatial proximity of the two classes of compounds, so that tungsten blue is directly supplied with the moisture required to lower the pH value, even under particularly dry conditions.

In another aspect of the present invention, the use of an antimicrobially active composite material as defined above for the manufacture of an antimicrobially active product is provided.

Another aspect of the present invention relates to a method of producing an antimicrobially active composite material as defined above. For this purpose, tungsten blue is combined with at least one further material.

Advantageously, in the preparation of a composite material, tungsten blue is combined with at least one hydrophilizing and/or hygroscopic agent as defined above, wherein the hydrophilizing and/or hygroscopic agent is arranged at least in the region of the surface of the composite material. It has proven to be particularly advantageous to coat and/or agglomerate tungsten blue at least partially with the hydrophilizing and/or hygroscopic agent, in particular SiO₂.

The present invention will be further illustrated by the following figures and examples.

### FIGURES

FIG. 1 shows the antimicrobial efficacy of tungsten blue (WP₃ 5% oxygen deficient, 1% in TPU) against the bacteria S. aureus and E. coli. After only 9 h, the samples tested are completely germ-free.

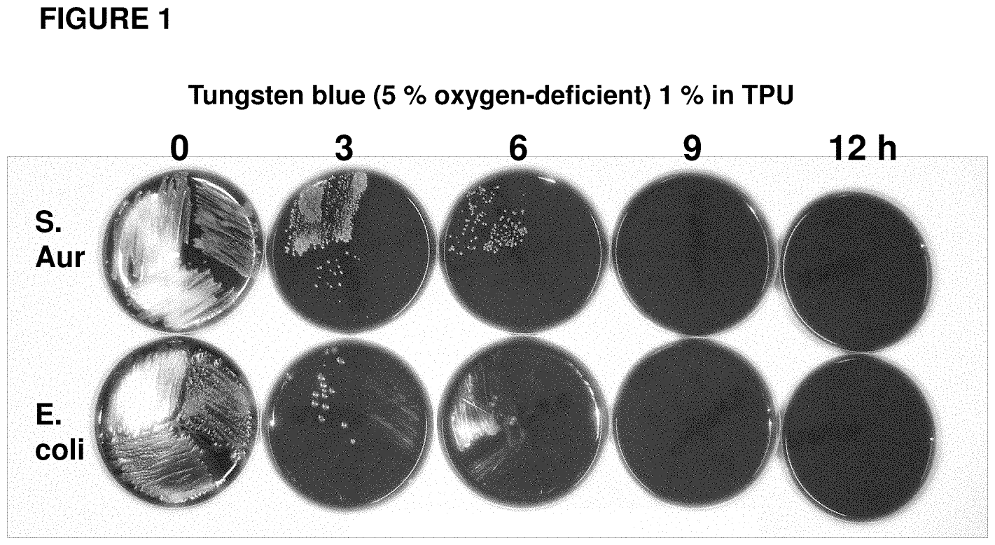

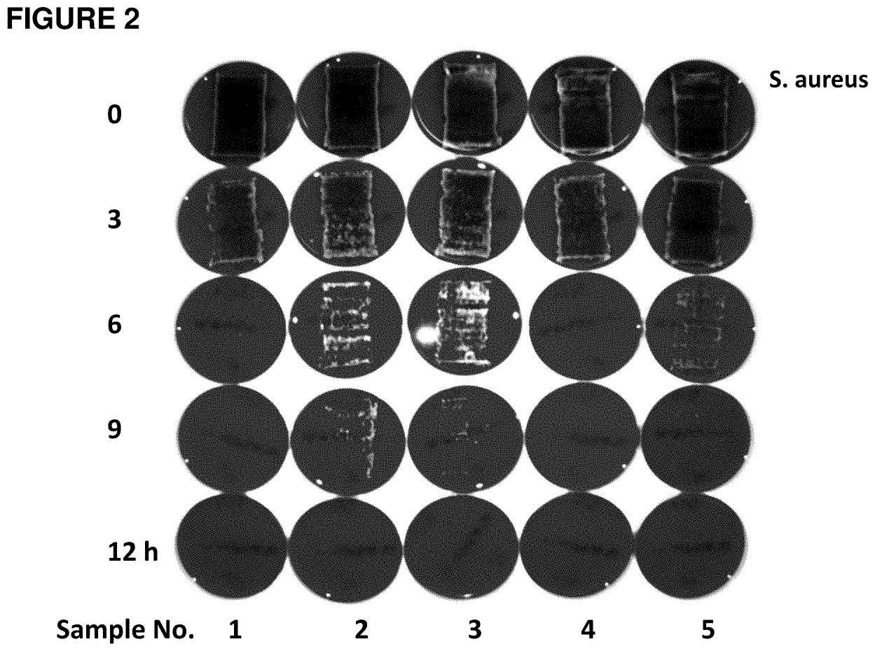

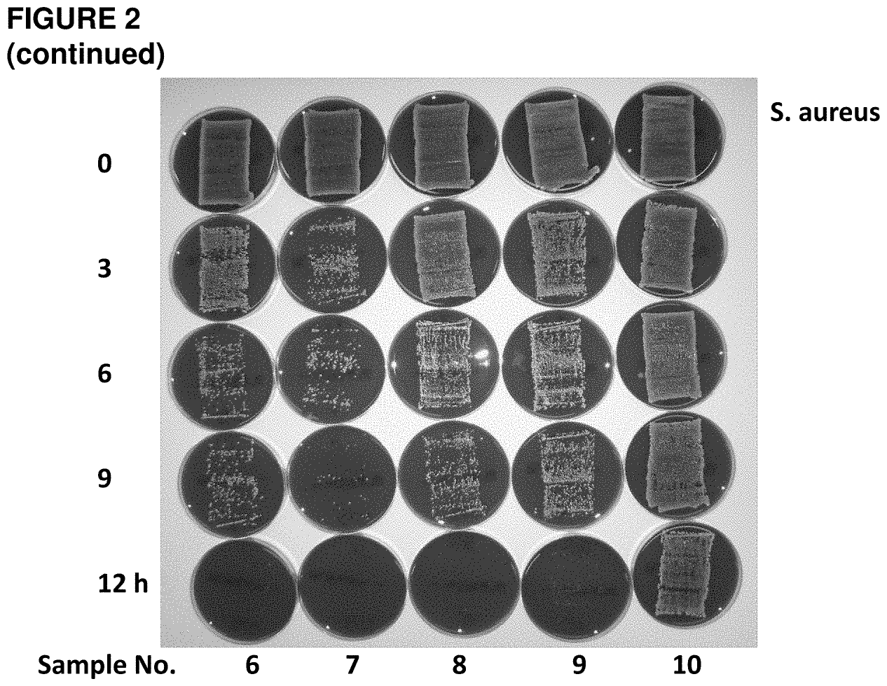

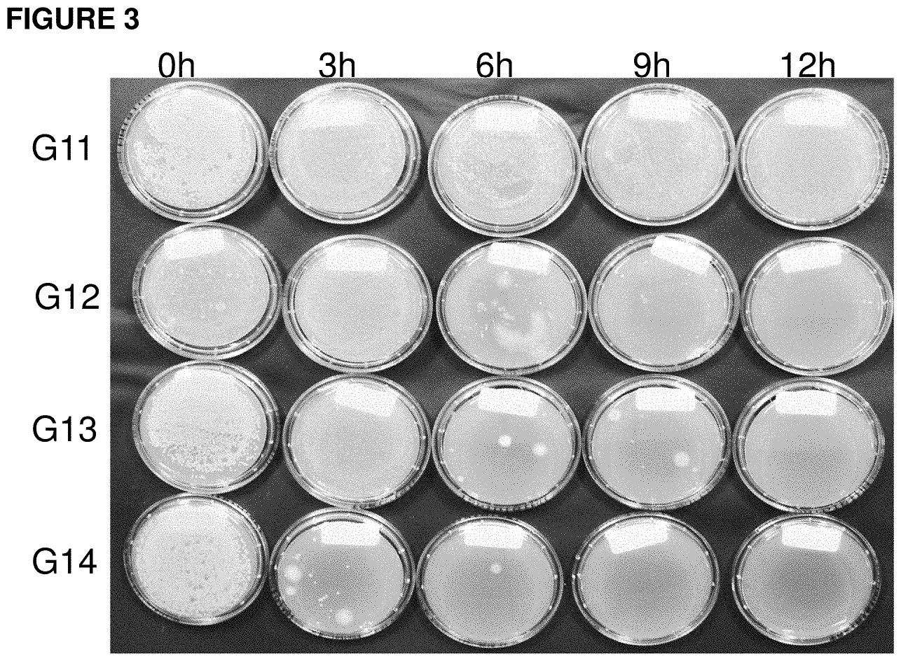

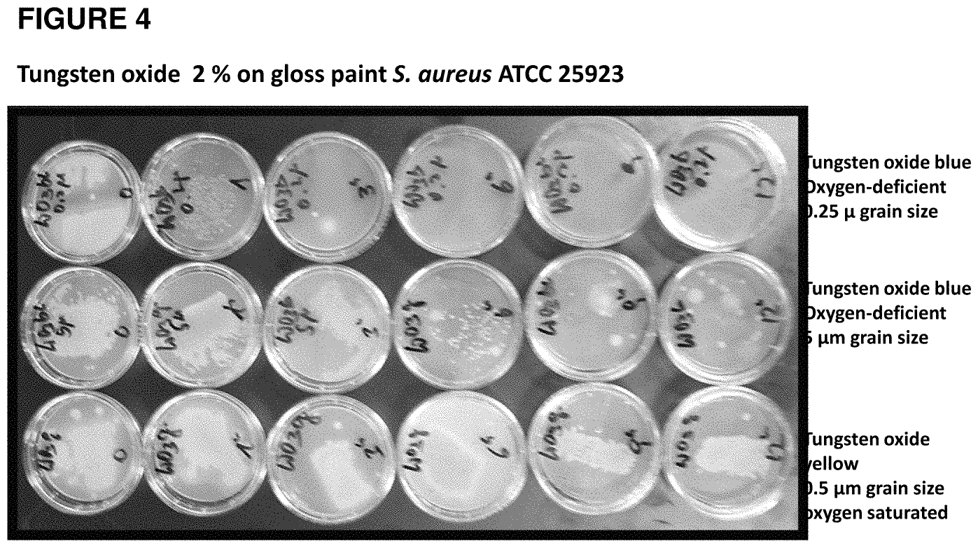

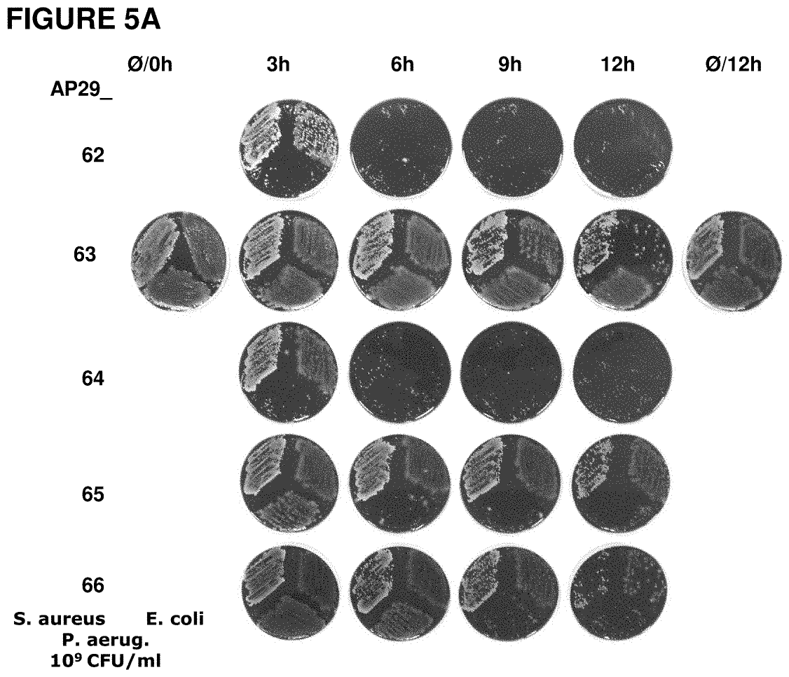

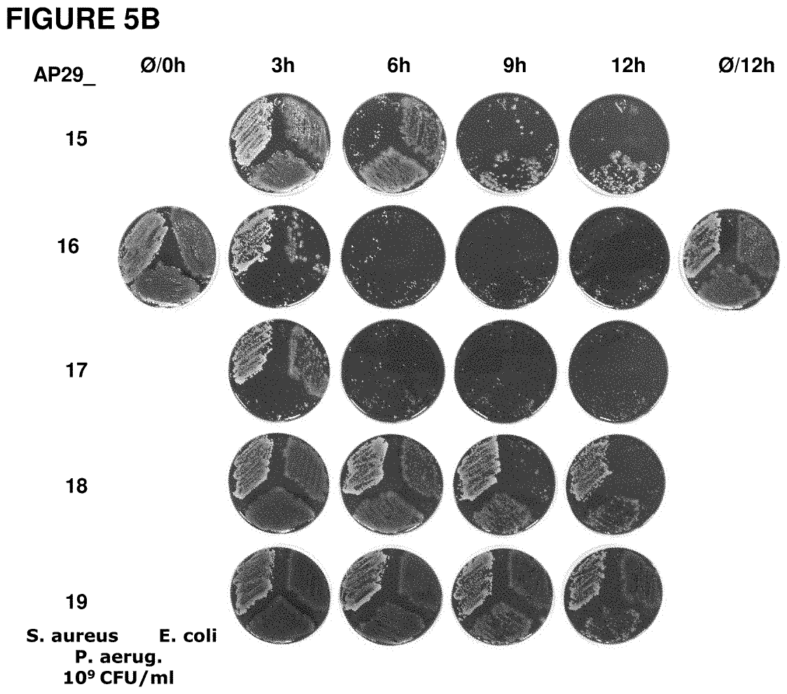

FIG. 2 shows a comparison of the effectiveness of tungsten blue with molybdenum(VI)oxide, tungsten(VI)oxide and various mixtures against S. aureus.
Sample no. 1: MoO₃,
No. 2, 3, 6: WO₃ (tungsten yellow),
No. 4, 7: tungsten blue (WP₃ 5% oxygen-deficient),
No. 5, 8, 9: mixture WO₃ (yellow)/tungsten blue,
No. 10: control
Tungsten blue is clearly superior to WO₃ (yellow) and shows almost complete sterility of the tested sample after 6 h. Mixtures of tungsten blue and tungsten yellow are also much less effective than pure tungsten blue.

FIG. 3 shows a comparison of the antimicrobial efficacy of tungsten yellow and tungsten blue at different concentrations.
G11: 1% WO₃ (yellow)
G12: 2% WO₃ (yellow)
G13: 1% tungsten blue
G14: 2% tungsten blue
Already in lower concentrations, tungsten blue is significantly more effective.

FIG. 4 shows the efficacy of tungsten blue against S. aureus depending on the particle size and in comparison with tungsten yellow. The tungsten oxides are each used at a concentration of 2%. For tungsten blue (5 oxygen-deficient), grain sizes of 0.25 μm and 5 μm are compared. The grain size of tungsten yellow is 0.5 μm.

FIG. 5 shows tests on the effectiveness of tungsten blue and tungsten yellow in combination with various additives. The germs were respectively S. aureus (left), E. coli (right) and P. aerug. (bottom). The following materials were examined:

5A: 62: PE+2% WO₃ (blue)+1% Disperplast 1150
63: PE+2% WO₃ (yellow)+1% Disperplast 1018
64: PE+2% WO₃ (blue)+1% Atmer 129 MB
65: PE+2% MoO₃+1% Palsgaard DMG0093
66: PE+1% Lubrophos LM-400E

5B: 15: PP+2% WO₃ (yellow/blue)+1% Crodafos MCA-SO
16: PP+2% WO₃ (blue)+1% Lubrophos LM-400E
17: PP+2% WO₃ (blue)+1% Pluronic PE 8100
18: PP+2% WO₃ (yellow)+1% Surfynol 440
19: PP+2% WO₃ (yellow)+1% Sodium dodecyl sulfate

In addition, average bacterial loads at the beginning of the test (T=0 h) and after 12 h are shown.

The efficacy of tungsten blue is significantly better in comparison with all other examined agents against all germs. It is also shown that mixtures of tungsten yellow and tungsten blue are significantly less effective than tungsten blue alone.

1. An antimicrobial agent comprising tungsten blue, wherein tungsten blue is oxygen-deficient WP₃, in particular WP₃ — 1 to 10 mole % oxygen, preferably WP₃— about 5 mole % oxygen, and wherein tungsten blue is present in the form of particles having an average particle size between 0.1 μm to 0.9 μm, preferably with an average particle size in the range from 0.2 to 0.7 μm, more preferably in the range of from 0.25 to 0.5 μm and wherein no particles having a particle size of less than 0.1 μm are present.

2. Antimicrobially active composite material comprising tungsten blue according to claim 1 and at least one further material.

3. The antimicrobially active composite material according to claim 2, further comprising at least one hydrophilizing and/or hygroscopizing agent which is arranged at least in the area of the surface of the composite material.

4. The composite material according to claim 3,
wherein the tungsten blue is at least partially coated and/or agglomerated with the hydrophilizing and/or hygroscopizing agent.

5. The composite material according to claim 3, wherein the hydrophilizing and/or hygroscopizing agent comprises SiO₂, in particular silica gel or fumed silica.

6. The composite material according to claim 2,
wherein the mass content of tungsten blue relative to the total mass of the composite is 0.1% to 80%, in particular 1.0% to 30%, and preferably 1.5% to 5.0%.

7. The composite material according to claim 2, wherein the further material comprises at least one organic polymer and/or silicone.

8. The composite material according to claim 2, which is formed as a layered composite, fiber composite, particle composite, or interpenetration composite.

9. A method of manufacturing an antimicrobially active product comprising adding an antimicrobially active composite material according to claim 2.

10. A method of making an antimicrobially active composite material according to claim 2, comprising combining tungsten blue with at least one further material.

11. The method according to claim 10, wherein at least one hydrophilizing and/or hygroscopic agent is arranged at least in the area of the surface of the composite material.

12. The method according to claim 11, wherein tungsten blue is at least partially coated and/or agglomerated with the hydrophilizing and/or hygroscopic agent.
